(19) United States
(12) Patent Application Publication
(10) Pub. No.: US 2024/0345227 A1
(43) Pub. Date: Oct. 17, 2024

(54) LIGHT EMITTING APPARATUS, DRIVE DEVICE, AND DISTANCE MEASUREMENT APPARATUS

(71) Applicant: FUJIFILM Business Innovation Corp., Tokyo (JP)

(72) Inventors: Junichiro Hayakawa, Kanagawa (JP); Kei Takeyama, Kanagawa (JP); Daisuke Iguchi, Kanagawa (JP)

(73) Assignee: FUJIFILM Business Innovation Corp., Tokyo (JP)

(21) Appl. No.: 18/585,027

(22) Filed: Feb. 22, 2024

(30) Foreign Application Priority Data
Apr. 17, 2023 (JP) 2023-067231

(51) Int. Cl. G01S 7/484; G01S 7/48; G01S 17/10

(52) U.S. Cl. CPC G01S 7/484; G01S 7/4808; G01S 17/10

(57) ABSTRACT

A light emitting apparatus includes: a light emitting unit that has plural regions configured to individually emit light; a drive unit that drives a predetermined region among the plural regions of the light emitting unit to perform pulse light emission; and an acquisition unit that acquires a light reception result obtained by receiving reflected light of the light emitted from the light emitting unit toward a target object, in which in one acquisition acquired by the acquisition unit, the drive unit drives the predetermined region such that the pulse light emission of the predetermined region is performed plural times with time intervals.

### CROSS-REFERENCE TO RELATED APPLICATIONS

This application is based on and claims priority under 35 USC 119 from Japanese Patent Application No. 2023-067231 filed Apr. 17, 2023.

### BACKGROUND

### (i) Technical Field

The present invention relates to a light emitting apparatus, a drive device, and a distance measurement apparatus.

### (ii) Related Art

For example, in JP2020-153796A, there is disclosed a distance measurement apparatus including a light projecting unit and a phase signal acquisition unit that receives light that is projected from the light projecting unit and is reflected by a target object, performs photoelectric conversion on the light, and obtains a phase signal by dividing a resultant electrical signal into a plurality of phase signals, and a distance output unit that outputs distance data to the target object acquired based on the plurality of phase signals, in which the light projecting unit includes a plurality of two-dimensionally arranged light emitting units and a light emitting control unit that causes the light emitting unit to emit light a plurality of times while changing positions of the plurality of light emitting units.

### SUMMARY

Here, in a case where an output of the light emitting unit is increased, it becomes possible to perform measurement over a long distance with higher accuracy. Therefore, a duty ratio is increased or a duration of pulse light emission is increased to increase the output. Meanwhile, in a case where the duty ratio is increased without changing the duration of pulse light emission, a phenomenon called thermal saturation in which the light output is affected is likely to occur. In addition, in a case where the duration of pulse light emission is increased, the thermal saturation occurs even at a low current.

Aspects of non-limiting embodiments of the present disclosure relate to a light emitting apparatus, a drive device, and a distance measurement apparatus that improve an output in a case where a duty ratio is increased, as compared with a case where an optical output is increased by increasing a duration of pulse light emission.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a light emitting apparatus including: a light emitting unit that has a plurality of regions configured to individually emit light; a drive unit that drives a predetermined region among the plurality of regions of the light emitting unit to perform pulse light emission; and an acquisition unit that acquires a light reception result obtained by receiving reflected light of the light emitted from the light emitting unit toward a target object, in which in one acquisition acquired by the acquisition unit, the drive unit drives the predetermined region such that the pulse light emission of the predetermined region is performed a plurality of times with time intervals.

### BRIEF DESCRIPTION OF THE DRAWINGS

Exemplary embodiment(s) of the present invention will be described in detail based on the following figures, wherein:

FIG. 1 is a block diagram illustrating an example of a schematic configuration of a distance measurement apparatus according to the present exemplary embodiment;

FIG. 2 is a diagram illustrating a relationship between a light emitting surface of a light emitting unit according to the present exemplary embodiment and an irradiation surface irradiated with light emitted from the light emitting unit;

FIG. 3 is a diagram illustrating an example of the light emitting unit according to the present exemplary embodiment;

FIG. 4 is a diagram illustrating a relationship between a light receiving surface of a light receiving unit according to the present exemplary embodiment and the irradiation surface;

FIGS. 5A to 5C are diagrams describing a distance image according to the present exemplary embodiment, FIG. 5A is a diagram illustrating a positional relationship between the distance measurement apparatus and a target object, FIG. 5B is a diagram illustrating an example of the distance image created by a control unit, and FIG. 5C is a diagram illustrating a state of the irradiation surface;

FIGS. 6A to 6D are diagrams describing a first operation pattern, FIGS. 6A to 6C illustrate a position of each section of a light emitting section and a light receiving section in number, and FIG. 6D illustrates the first operation pattern;

FIG. 7 is a diagram illustrating a second operation pattern;

FIGS. 8A to 8F are diagrams illustrating a third operation pattern, and illustrate a position of each section of the light emitting section and the light receiving section in number;

FIG. 9 is a diagram illustrating the third operation pattern; and

FIG. 10 is a diagram illustrating a light emitting operation pattern in one light emitting period to which the present exemplary embodiment is applied.

### DETAILED DESCRIPTION

Hereinafter, exemplary embodiments of the present invention will be described in detail with reference to the accompanying drawings.

The technical scope of the present invention is not limited to the scope to be described below as an exemplary embodiment. It is clear from the description of the claims that a combination of a plurality of examples and various modifications or improvements to the exemplary embodiment described above are also included in the technical scope of the present invention.

### Distance Measurement Apparatus 1

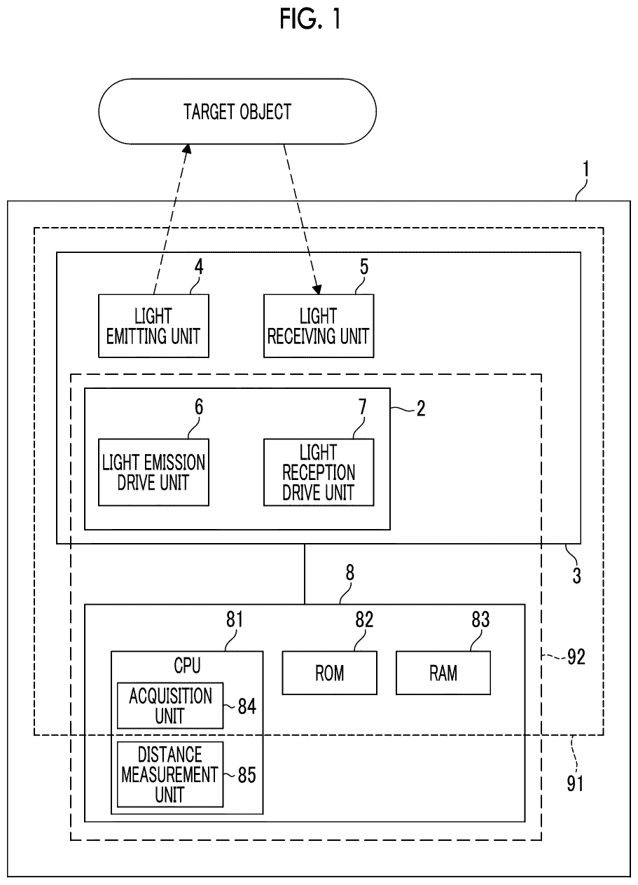

FIG. 1 is a block diagram illustrating an example of a schematic configuration of a distance measurement apparatus 1 according to the present exemplary embodiment.

The distance measurement apparatus 1 measures a distance of a target object based on a result of receiving light emitted from a light emitting unit 4 to be described below and reflected by the target object by a light receiving unit 5 to be described below. The distance measurement apparatus 1 measures a distance from the distance measurement apparatus 1 to the target object based on a time of flight (ToF) method, for example. In addition, the distance measurement apparatus 1 measures the distance from the distance measurement apparatus 1 to the target object based on a time from a timing at which light is emitted from the light emitting unit 4 to a timing at which the emitted light is reflected by the target object and received by the light receiving unit 5. In some cases, measuring the distance is described as length measurement or distance measurement. The ToF method includes an indirect ToF (iToF) method in which a time is measured from a difference between a phase of radiated light and a phase of received light, and a direct ToF (dToF) method in which a time from light radiation to reception of light is directly measured. Here, the indirect ToF method and the direct ToF method are not distinguished and are described as the ToF method.

As illustrated in FIG. 1, the distance measurement apparatus 1 includes an optical device 3 and a control unit 8.

The optical device 3 includes the light emitting unit 4 that emits light toward a predetermined irradiation range, a light receiving unit 5 that receives the light emitted from the light emitting unit 4 and reflected by a target object existing in the irradiation range, and a drive unit 2 that includes a light emission drive unit 6 that drives the light emitting unit 4 and a light reception drive unit 7 that drives the light receiving unit 5.

Details of the configurations of the light emitting unit 4 and the light receiving unit 5 of the optical device 3 will be described below.

The control unit 8 controls the operations of the light emitting unit 4 and the light receiving unit 5 of the optical device 3.

In addition, by the ToF method, the control unit 8 acquires information on a distance from the distance measurement apparatus 1 to the target object based on a time since the light emitting unit 4 emits light until the light receiving unit 5 receives the light, and includes an acquisition unit 84 and a distance measurement unit 85.

The acquisition unit 84 acquires a light reception result obtained by receiving the reflected light of the light emitted from the light emitting unit 4 toward the target object. The distance measurement unit 85 measures a distance to the target object based on the light reception result acquired by the acquisition unit 84.

As illustrated in FIG. 1, a light emitting apparatus 91 is configured to include the drive unit 2, the light emitting unit 4, the light receiving unit 5, and the acquisition unit 84. Further, the distance measurement apparatus 1 is configured to include the light emitting apparatus 91 and the distance measurement unit 85. The distance measurement unit 85 is an example of a calculation unit.

More specifically, the drive device 92 is configured to include the drive unit 2 and the acquisition unit 84.

### Light Emitting Unit 4

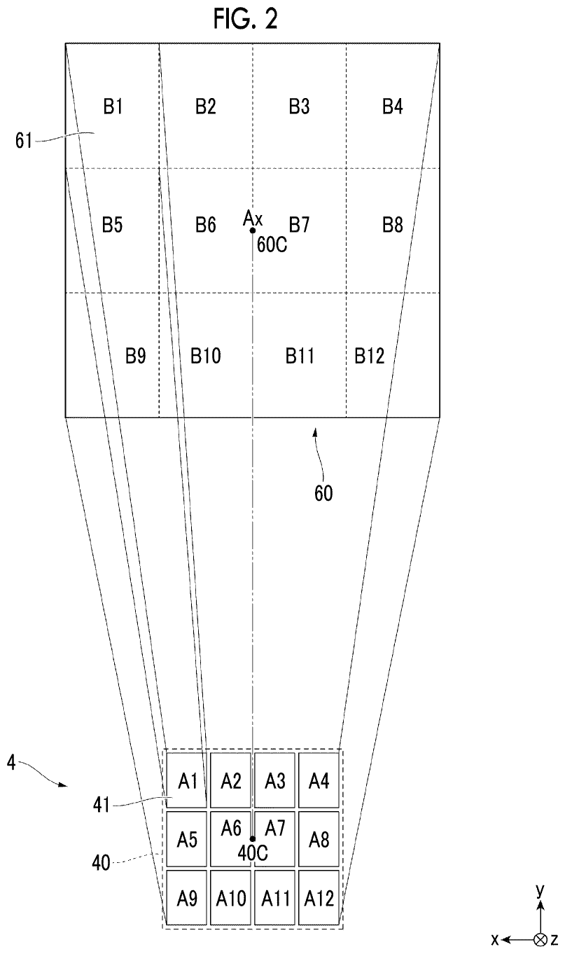

FIG. 2 is a diagram illustrating a relationship between a light emitting surface 40 of the light emitting unit 4 according to the present exemplary embodiment and an irradiation surface 60 irradiated with light emitted from the light emitting unit 4. A left direction of the page plane of FIG. 2 is a +x direction, an upward direction of the page plane of FIG. 2 is a +y direction, a back side direction of the page plane of FIG. 2 is a +z direction, and each opposite directions are −x, −y, and −z directions. Although the light emitting surface 40 and the irradiation surface 60 are illustrated to deviate in an up-down direction (±y direction) of the page plane of FIG. 2, the light emitting surface 40 and the irradiation surface 60 are actually disposed to face each other. The light emitting surface 40 of the light emitting unit 4 is located in a front side direction (−z direction) of the page plane of FIG. 2, and the irradiation surface 60 is located in a back side direction (+z direction) of the page plane of FIG. 2. That is, FIG. 2 illustrates a state of the light emitting unit 4 that emits light to the irradiation surface 60 as viewed from a side opposite to a side on which the light emitting unit 4 emits the light.

The light emitting unit 4 is configured with, for example, one or a plurality of light emitting chips. The light emitting unit 4 is an example of a light emitting device.

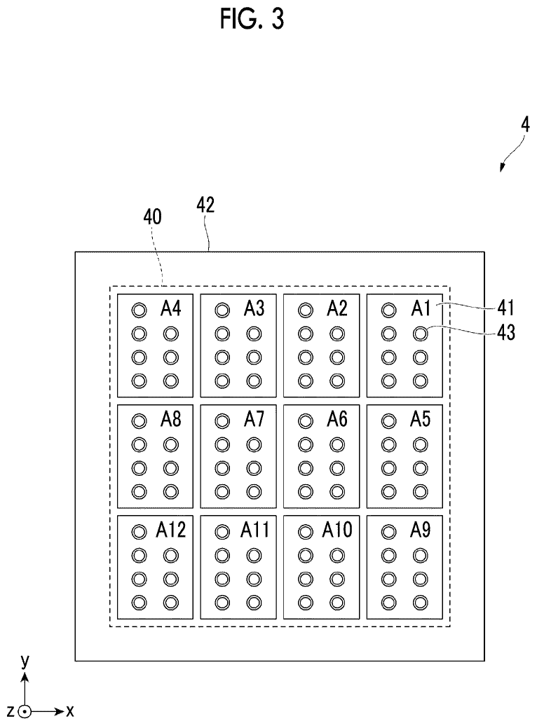

The light emitting unit 4 includes the light emitting surface 40 on which a plurality of vertical cavity surface emitting lasers (VCSELs, referred to by reference numeral 43 in FIG. 3 to be described below) are arranged. The light emitting unit 4 emits light toward the irradiation surface 60 by light emission of the VCSEL. The VCSEL is an example of a light emitting element. In FIG. 2, the VCSEL is not illustrated.

The light emitting surface 40 is divided into a plurality of light emitting sections 41 including at least one VCSEL. Here, as an example, the light emitting surface 40 is divided into 12 light emitting sections 41 in a total of four light emitting sections 41 in the x-direction and three light emitting sections 41 in the y-direction. As illustrated in FIG. 2, in a case where it is necessary to distinguish the light emitting sections 41 from each other, the light emitting sections 41 are distinguished as light emitting sections A1 to A12 in order from the upper left side (ends in the +x direction and the +y direction) in FIG. 2. The light emitting sections A1 to A12 are examples of a plurality of regions.

The light emitting surface 40 in the present exemplary embodiment is divided into the 12 light emitting sections 41. Meanwhile, the present exemplary embodiment is not limited to this, and other division numbers may be used.

In the present exemplary embodiment, the term “to” indicates a plurality of components distinguished individually by numbers, and means that components before and after “to” and components having numbers between the components are included. For example, the light emitting sections A1 to A12 include 12 light emitting sections 41 from the light emitting section A1 to the light emitting section A12 in numerical order.

Each light emitting section 41 is independently driven by the light emission drive unit 6 (see FIG. 1) to perform a light emitting operation. The driving of the light emitting section 41 means that power is supplied to the VCSEL included in the light emitting section 41 to emit light, and the light emitting operation means that the VCSEL included in the light emitting section 41 emits the light for a predetermined light emitting period. The term “independently driven” indicates that each light emitting section 41 is driven to emit light. The light emission drive unit 6 drives each light emitting section 41 in response to a control signal from the control unit 8 (see FIG. 1).

Thus, the light emitting sections A1 to A12 in the example in FIG. 2 do not always emit the light simultaneously, and for example, may be in a state in which, while the light emitting section A1 emits light, the light emitting section A12 does not emit light.

The irradiation surface 60 is a surface that is perpendicular to a direction in which light is emitted at a certain distance from a center 40C of the light emitting surface 40, and irradiated with the light from the light emitting unit 4.

In the example in FIG. 2, the light emitting unit 4 emits light in a z-direction. Thus, the irradiation surface 60 extends in the x-direction and the y-direction at a certain distance in the z-direction. A central axis Ax (two-dot chain line) passing through a center 60C of the irradiation surface 60 and the center 40C of the light emitting surface 40 is perpendicular to the light emitting surface 40 and the irradiation surface 60. In the present exemplary embodiment, as the light emitting surface 40 has a rectangular shape, the irradiation surface 60 has a rectangular shape.

As illustrated in FIG. 2, the irradiation surface 60 is divided into a plurality of irradiation sections 61, corresponding to the light emitting sections 41 in the light emitting surface 40. In the example of FIG. 2, the irradiation surface 60 is divided into 12 irradiation sections 61 of four irradiation sections 61 in the x-direction and three irradiation sections 61 in the y-direction. In a case where it is necessary to distinguish the irradiation sections 61 from each other, irradiation sections B1 to B12 are distinguished in order from the upper left side (ends in the +x direction and the +y direction) in FIG. 2.

A light emitting section Ai to which the same number i as a number of a certain irradiation section Bi is assigned may be referred to as a “corresponding light emitting section”. For example, the light emitting section A1 is a light emitting section corresponding to the irradiation section B1. On the contrary, an irradiation section Bi to which the same number i as a number of a certain light emitting section Ai is assigned may be referred to as a “corresponding irradiation section”.

The irradiation sections B1 to B12 have a plane-symmetrical arrangement to the light emitting sections A1 to A12 based on an xy plane. For example, as the irradiation sections B1, B2, B3, and B4 are arranged in this order in the −x direction, the light emitting sections A1, A2, A3, and A4 are arranged in this order in the −x direction.

Each light emitting section 41 emits light toward the corresponding irradiation section 61. Each irradiation section 61 is irradiated with the light emitted from the corresponding light emitting section 41. Here, the fact that the light emitting section 41 emits the light toward the corresponding irradiation section 61 means that an optical axis of the light emitted from each light emitting section 41 faces the corresponding irradiation section 61, and all of the light emitted from the light emitting section 41 may be not emitted onto the corresponding irradiation section 61. Although details will be described below, in the present exemplary embodiment, a range of light emitted from each irradiation section 61 is larger than a range of the corresponding light emitting section 41. Accordingly, in some cases, each irradiation section 61 may be irradiated with light emitted from another light emitting section 41 other than the corresponding light emitting section 41.

FIG. 3 is a diagram illustrating an example of the light emitting unit 4 according to the present exemplary embodiment. FIG. 3 illustrates a state of the light emitting unit 4 as viewed from a light emission side. Accordingly, in FIG. 3, a right direction of the page plane is the x-direction, an upward direction of the page plane is the y-direction, and a front direction of the page plane is the z-direction. A plan view is a diagram as the light emitting unit 4 is viewed from the z-direction side.

As illustrated in FIG. 3, the light emitting unit 4 has a substrate 42, and the light emitting surface 40 on which a plurality of VCSELs 43 are disposed. In more detail, the substrate 42 and the light emitting surface 40 are provided to overlap with each other in a direction (the +z direction or the front direction of the page plane of FIG. 3) in which light is emitted.

FIG. 3 is a diagram illustrating an example of the light emitting unit 4 according to the present exemplary embodiment. FIG. 3 illustrates a state of the light emitting unit 4 as viewed from a light emission side. Accordingly, in FIG. 3, a right direction of the page plane is the x-direction, an upward direction of the page plane is the y-direction, and a front direction of the page plane is the z-direction. A plan view is a diagram as the light emitting unit 4 is viewed from the z-direction side.

As illustrated in FIG. 3, the light emitting unit 4 has a substrate 42, and the light emitting surface 40 on which a plurality of VCSELs 43 are disposed. In more detail, the substrate 42 and the light emitting surface 40 are provided to overlap with each other in a direction (the +z direction or the front direction of the page plane of FIG. 3) in which light is emitted.

As described above, the light emitting unit 4 includes the 12 light emitting sections 41 (light emitting sections A1 to A12) in which the VCSELs 43 are arranged on the light emitting surface 40. As illustrated in FIG. 3, the light emitting sections A1 to A12 all have the same area. In addition, the same number (7 in this example) of VCSELs 43 are arranged in each of the light emitting sections A1 to A12.

The light emitted from each light emitting section 41 of the light emitting unit 4 is spread with a plane perpendicular to the emission direction (the axial direction of the central axis Ax) by a diffusion unit (not illustrated) and is emitted to the irradiation surface 60. In addition, in this example, the light emitted from each light emitting section 41 of the light emitting unit 4 is spread over a larger range than the corresponding irradiation section 61 by the diffusion unit that diffuses the light, and is emitted to the irradiation surface 60. As the diffusion unit, an optical member such as a diffusion plate that is provided on an optical path of the light to diffuse the light with scattering or the like, and a diffractive optical element (DOE) or/and a lens that changes an angle of the incident light and emits the light can be used.

### Light Receiving Unit 5

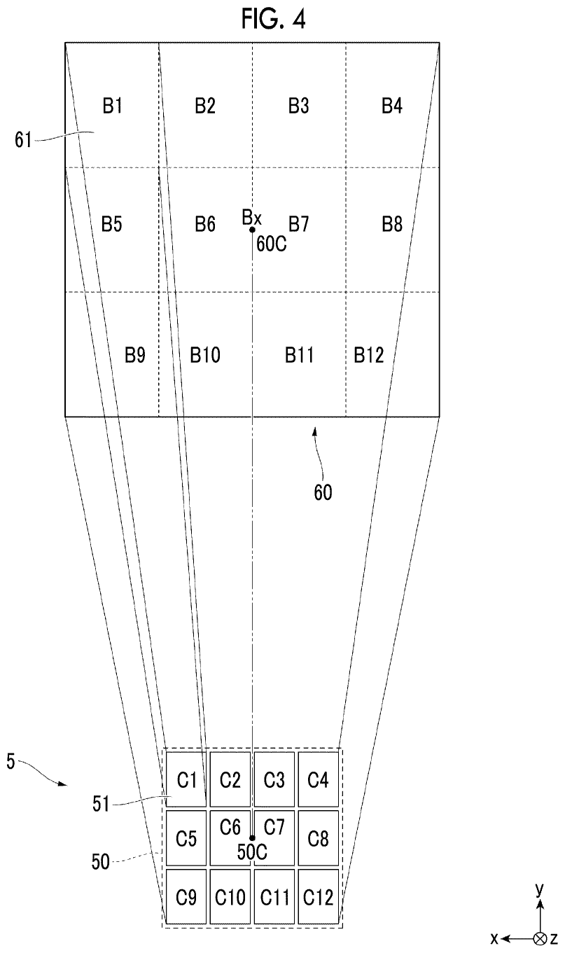

FIG. 4 is a diagram illustrating a relationship between a light receiving surface 50 of the light receiving unit 5 according to the present exemplary embodiment and the irradiation surface 60 described above. In the same manner as FIG. 2, a left direction of the page plane of FIG. 4 is a +x direction, an upward direction of the page plane of FIG. 4 is a +y direction, a back side direction of the page plane of FIG. 4 is a +z direction, and each opposite directions are −x, −y, and −z directions. Although the light receiving surface 50 and the irradiation surface 60 are illustrated to deviate in the up-down direction (±y direction) of the page plane of FIG. 4, the light receiving surface 50 and the irradiation surface 60 are actually disposed to face each other. The light receiving unit 5 (light receiving surface 50) is located in the front side direction (−z direction) of the page plane of FIG. 4, and the irradiation surface 60 is located in the back side direction (+z direction) of the page plane of FIG. 4. That is, FIG. 4 illustrates a state of the light receiving unit 5 that receives light reflected from the irradiation surface 60 as viewed from a side opposite to a side on which the light receiving unit 5 receives the light.

The light receiving unit 5 extends in the x-direction and the y-direction, and includes the light receiving surface 50 in which a plurality of light receiving elements (not illustrated) are arranged. The light receiving unit 5 receives the light emitted from the light emitting unit 4 and reflected by a target object existing at the irradiation surface 60, by each light receiving element.

A central axis Bx (two-dot chain line) passing through the center 60C of the irradiation surface 60 and a center 50C of the light receiving surface 50 is perpendicular to the irradiation surface 60 and the light receiving surface 50. In the present exemplary embodiment, in the same manner as the light emitting surface 40 (see FIG. 2) and the irradiation surface 60, the light receiving surface 50 has a rectangular shape.

The light receiving surface 50 is divided into a plurality of light receiving sections 51 corresponding to the light emitting sections 41 (see FIG. 2) of the light emitting surface 40 (see FIG. 2) and the irradiation sections 61 of the irradiation surface 60. In the example of FIG. 4, the light receiving surface 50 is divided into 12 light receiving sections 51 of four light receiving sections 51 in the x-direction and three light receiving sections 51 in the y-direction. In a case where it is necessary to distinguish the light receiving sections 51 from each other, the light receiving sections 51 are distinguished as light receiving sections C1 to C12 in order from the upper left side (ends in the +x direction and +y direction) in FIG. 4.

A light receiving section Ci to which the same number i as a number of a certain light emitting section Ai and a certain irradiation section Bi is assigned may be referred to as a “corresponding light receiving section”. For example, the light receiving section C1 is a light receiving section corresponding to the light emitting section A1 or the irradiation section B1. On the contrary, the light emitting section Ai to which the same number as a number of a certain light receiving section Ci is assigned is referred to as a “corresponding light emitting section”, and the irradiation section Bi to which the same number as a number of a certain light receiving section Ci is assigned is referred to as “corresponding irradiation section”, in some cases.

The light receiving sections C1 to C12 have a plane-symmetrical arrangement to the irradiation sections B1 to B12 based on the xy plane. For example, in FIG. 4, as the irradiation sections B1, B2, B3, and B4 are arranged in this order in the −x direction, the light receiving sections C1, C2, C3, and C4 are arranged in this order in the −x direction.

Each light receiving section 51 receives light emitted from the light emitting unit 4 and reflected by a target object existing at the corresponding irradiation section 61.

Each light receiving section 51 has a plurality of light receiving elements that are regularly arranged. Each light receiving element can receive light emitted from the light emitting unit 4 and reflected by a target object existing at the irradiation surface 60, and can output an electric signal in response to the received light. Examples of the light receiving element include a photodiode or a phototransistor.

Each light receiving section 51 is independently driven by the light reception drive unit 7 (see FIG. 1) to perform a light receiving operation. Here, the drive of the light receiving section 51 means that the light receiving section 51 is in a state capable of accumulating a charge corresponding to the light reception of the light receiving element, and the light receiving operation means that the light receiving element of the light receiving section 51 accumulates the charge in response to the light reception. In addition, the term “independently driven” indicates that each light receiving section 51 is driven to enter a state in which the charge can be accumulated in response to the light reception. The light reception drive unit 7 drives each light receiving section 51 in response to a control signal from the control unit 8 (see FIG. 1).

In addition, the light receiving unit 5 outputs an electric signal corresponding to the charge accumulated in the light receiving section 51, that is, a result of the light received in the light receiving section 51 to the control unit 8, in accordance with a read operation of the control unit 8 (details will be described below).

### Control Unit 8

With reference to FIG. 1, the control unit 8 is configured with a central processing unit (CPU) 81, a read only memory (ROM) 82, and a random access memory (RAM) 83.

The CPU 81 is an example of a processor, and implements each function, which will be described below, by loading various programs stored in the ROM 82 or the like into the RAM 83 and executing the programs. The RAM 83 is a memory used as a work memory or the like of the CPU 81. The ROM 82 is a memory which stores various programs and the like executed by the CPU 81.

The CPU 81 includes the acquisition unit 84 and the distance measurement unit 85 realized by a program. The acquisition unit 84 acquires a light reception result obtained by receiving the reflected light of the light emitted from the light emitting unit 4 toward the target object. The distance measurement unit 85 measures a distance to a target object based on a light reception result acquired by the acquisition unit 84.

Here, the program executed by the CPU 81 may be provided in a state of being stored in a computer-readable recording medium such as a magnetic recording medium (a magnetic tape, a magnetic disk, or the like), an optical recording medium (an optical disk or the like), a magneto-optical recording medium, or a semiconductor memory. The program executed by the CPU 81 may be provided by using a communication section such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

As described above, the control unit 8 controls the operation of the light emitting unit 4 through the light emission drive unit 6 of the drive unit 2, and controls the operation of the light receiving unit 5 through the light reception drive unit 7 of the drive unit 2.

In addition, the acquisition unit 84 of the control unit 8 performs a read operation on the light receiving unit 5 through the light reception drive unit 7. Here, the term “read operation” means that the control unit 8 controls the light receiving unit 5 through the light reception drive unit 7 and causes the light receiving unit 5 to output an electric signal corresponding to a result of light reception by the light receiving element in the light receiving section 51, and acquires the electric signal. The control unit 8 according to the present exemplary embodiment can independently perform the read operation for each light receiving section 51. For example, in a case where a certain light receiving section Ci and another light receiving section Cj perform a light receiving operation to accumulate a charge, not only a read operation can be performed on both the light receiving section Ci and the light receiving section Cj but also the read operation can be performed on only the light receiving section Ci.

Meanwhile, in general, in the indirect ToF method, light is received with a plurality of phase differences with respect to emission of light, and a difference between the phase of the emitted light and the phase of the received light is obtained from the result of the light reception at each phase difference to measure a distance. Further, in general, in order to reduce a decrease in distance measurement accuracy by external light (ambient light), light reception is performed a plurality of times for one phase difference. Therefore, in a case where light reception is performed k times at each of n phase differences φ (φ1, φ2, . . . , and φn), emission of light, reception of the light at a certain phase difference φ, and reading of a result of the light reception are repeated n x k times.

In the distance measurement apparatus 1 to which the present exemplary embodiment is applied, a distance is measured based on the indirect ToF method, from a result of performing light reception twice at each of two phase differences φ of 0 degrees and 180 degrees with respect to emission of light. Thus, in a case of performing distance measurement of, for example, a certain irradiation section Bi in the distance measurement apparatus 1, a light emitting operation in the corresponding light emitting section Ai, a light receiving operation in the corresponding light receiving section Ci, and a read operation for the light receiving section Ci by the control unit 8 are respectively repeated 4 times. More specifically, in the distance measurement apparatus 1, four light emitting operations in each light emitting section 41, four light receiving operations in each light receiving section 51, and four read operations for each light receiving section 51 are performed according to a predetermined operation pattern. This predetermined operation pattern will be described below.

The control unit 8 performs distance measurement of each irradiation section 61, based on a result of light reception in each light receiving section 51. The results of distance measurement in each irradiation section 61 are collected, and a distance image representing the distance between the distance measurement apparatus 1 and the target object is created. More specifically, the distance measurement unit 85 of the control unit 8 calculates (performs distance measurement) a distance between the distance measurement apparatus 1 and the target object in each irradiation section 61 of the irradiation surface 60 by performing a predetermined arithmetic process on four electric signals acquired from the light receiving unit 5 as results of the four light receptions in each light receiving section 51, and creates a distance image.

### Distance Image 100

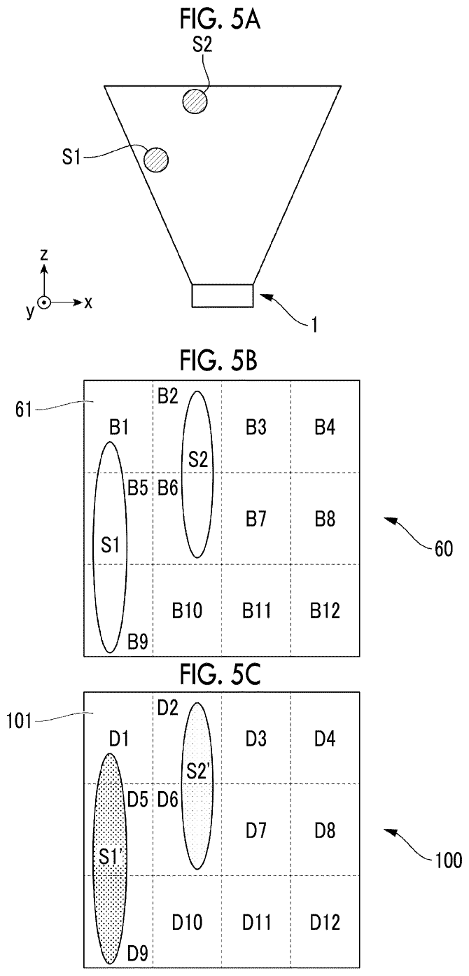

FIGS. 5A to 5C are diagrams describing a distance image 100 according to the present exemplary embodiment, FIG. 5A is a diagram illustrating a positional relationship between the distance measurement apparatus 1 and target objects S1 and S2, FIG. 5B is a diagram illustrating an example of the distance image 100 created by the control unit 8, and FIG. 5C is a diagram illustrating a state of the irradiation surface 60.

The distance image 100 illustrated in FIG. 5B is created as a result of performing distance measurement on all the irradiation sections 61 of the irradiation surface 60. In the example of 5A to 5C, it is assumed that the target objects S1 and S2 (may be referred to as a target object S without distinguishing the target objects S1 and S2) are stopped at least from a start to an end of distance measurement required for creating the distance image 100 by the distance measurement apparatus 1 and a position with respect to the distance measurement apparatus 1 is not changed.

As illustrated in FIG. 5C, the distance image 100 has a plurality of image sections 101 corresponding to the light emitting sections 41 of the light emitting surface 40, the irradiation sections 61 of the irradiation surface 60, and the light receiving sections 51 of the light receiving surface 50 (see FIGS. 2 and 4). In the example of FIG. 5C, the distance image 100 has 12 image sections 101 of four image sections 101 arranged in a right-left direction of FIG. 5C corresponding to the ±x direction of the irradiation surface 60 and the light receiving surface 50, and three image sections 101 arranged in the up-down direction of FIG. 5C corresponding to the ±y direction. In a case where it is necessary to distinguish the image sections 101 from each other, image sections D1 to D12 are distinguished in order from the upper left side in FIG. 5C.

An image section Di in the distance image 100 is an image obtained based on light emitted by the light emitting section Ai of the light emitting surface 40, reflected by the target object at the irradiation section Bi of the irradiation surface 60, and received in the light receiving section Ci of the light receiving surface 50. The image section Di to which the same number i as a number of the light emitting section Ai, the irradiation section Bi, and the light receiving section Ci is assigned may be referred to as a “corresponding image section”. On the contrary, in some cases, the light emitting section Ai to which the same number i as a number of the image section Di is assigned is referred to as a “corresponding light emitting section”, the irradiation section Bi to which the same number i as a number of the image section Di is assigned is referred to as a “corresponding irradiation section”, and the light receiving section Ci to which the same number i as a number of the image section Di is assigned is referred to as a “corresponding light receiving section”.

Each image section 101 of the distance image 100 has a plurality of pixels (not illustrated) associated with the plurality of light receiving elements included in the corresponding light receiving section 51. In the distance image 100, a pixel value of each pixel of the image section 101 corresponds to a distance from the distance measurement apparatus 1 to the target object, which is calculated from the electric signal from each light receiving element of the light receiving section 51.

In the example illustrated in FIG. 5A, the target objects S1 and S2 exist at positions separated from the distance measurement apparatus 1 by a certain distance. As illustrated in FIG. 5B, the target object S1 in this example exists in a range across the irradiation sections B1, B5, and B9 of the irradiation surface 60, and the target object S2 exists in a range across the irradiation sections B2 and B6. Further, a distance from the distance measurement apparatus 1 to the target object S1 (for example, approximately 1 m) is smaller than a distance from the distance measurement apparatus 1 to the target object S2 (for example, approximately 3 m).

As illustrated in FIG. 5C, in the distance image 100, an image S1′ representing the target object S1 and an image S2′ representing the target object S2 (may be referred to as an image S′ without distinguishing the image S1′ and the image S2′) are illustrated by pixels included in each image section 101. More specifically, the image S1′ is illustrated across the image sections D1, D5, and D9 corresponding to the irradiation sections B1, B5, and B9 in the distance image 100, and the image S2′ is illustrated across the image sections D2 and D6 corresponding to the irradiation sections B2 and B6 in the distance image 100.

In this example, information on a distance from the distance measurement apparatus 1 to the target object S1 and a distance from the distance measurement apparatus 1 to the target object S2 can be obtained by pixel values (represented by shading in FIG. 5C) of pixels constituting the image S1′ and the image S2′ in the distance image 100.

Since the distance image 100 includes information on a distance between each point on a surface of the target object S and the distance measurement apparatus 1, the distance image 100 may be considered to include information on a three-dimensional shape of the target object S. Thus, the distance measurement apparatus 1 to which the present exemplary embodiment is applied can also be used for three-dimensional measurement.

### Operation Pattern

Next, a first operation pattern, a second operation pattern, and a third operation pattern will be described as various operation patterns to be controlled by the control unit 8.

Further, the operation patterns will be described by using a case where a light emitting period of each light emitting section 41 is 500 μs as an example. That is, as the light emitting operation, each light emitting section 41 is driven by the light emission drive unit 6 (see FIG. 1) and causes the VCSEL to emit light for 500 μs such that the corresponding irradiation section 61 is irradiated with the light. The light emitting period is not limited to 500 μs, and is determined in advance according to the amount of light or the like required to secure the accuracy of distance measurement.

In the operation pattern to be described below, a case will be described in which each light emitting section 41 has the scheduled number of four light emitting periods, which is a predetermined plurality of times. The scheduled number of times referred to here is not limited. For example, in the indirect ToF method, in some cases, distance measurement is performed based on results of light reception twice at each of four phase differences φ of 0 degrees, 90 degrees, 180 degrees, and 270 degrees with respect to light emission. Thus, in a case of performing distance measurement of, for example, a certain irradiation section Bi in the distance measurement apparatus 1, a light emitting operation in the corresponding light emitting section Ai, a light receiving operation at the phase difference p in the corresponding light receiving section Ci, and a read operation for the light receiving section Ci by the control unit 8 are respectively repeated eight times. More specifically, the light emitting operation is performed eight times in each light emitting section 41, the light receiving operation is performed eight times in each light receiving section 51, and the read operation is performed eight times for each light receiving section 51.

### First Operation Pattern

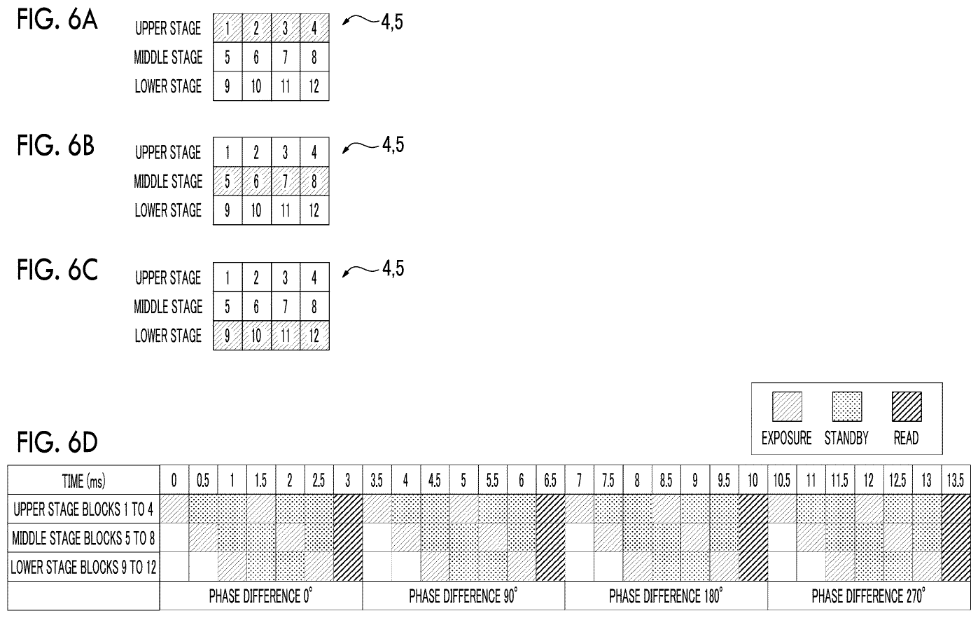

First, a first operation pattern will be described with reference to FIGS. 6A to 6D.

FIGS. 6A to 6D are diagrams describing the first operation pattern, FIGS. 6A to 6C illustrate a position of each section of the light emitting sections A1 to A12 (see FIG. 3) of the light emitting unit 4 and the light receiving sections C1 to C12 (see FIG. 4) of the light receiving unit 5 in number, and FIG. 6D is a diagram illustrating the first operation pattern indicating timings of an exposure, a standby, and a read.

In FIGS. 6A to 6C, blocks that emit light at the same time are shaded. Further, in FIG. 6D, an exposure period is indicated by diagonal lines of the same type as in FIG. 6A to FIG. 6C, a standby period is indicated by dots, and a read period is indicated by diagonal lines of thick lines.

In addition, a period divided by 0.5 ms illustrated in FIG. 6D may be represented as a cell, and may be described as one cell as a unit of an exposure period, a standby period, and a read period.

In FIGS. 6A to 6C, the light emitting sections A1 to A12 (see FIG. 3) of the light emitting unit 4 and the light receiving sections C1 to C12 (see FIG. 4) of the light receiving unit 5 are divided into three stages in the y-direction, and are indicated by an upper stage block, a middle stage block, and a lower stage block. That is, the upper stage blocks are the light emitting sections A1 to A4 and the light receiving sections C1 to C4, the middle stage blocks are the light emitting sections A5 to A8 and the light receiving sections C5 to C8, and the lower stage blocks are the light emitting sections A9 to A12 and the light receiving sections C9 to C12. Hereinafter, the upper stage blocks are referred to as “upper stage blocks 1 to 4”, the middle stage blocks are referred to as “middle stage blocks 5 to 8”, and the lower stage blocks are referred to as “lower stage blocks 9 to 12”. Each of the upper stage blocks 1 to 4, the middle stage blocks 5 to 8, and the lower stage blocks 9 to 12 is an example of a predetermined region.

As illustrated in FIGS. 6A to 6C, the upper stage blocks 1 to 4, the middle stage blocks 5 to 8, and the lower stage blocks 9 to 12 are disposed side by side in a right-left direction, that is, in one direction, and have a row shape.

In FIGS. 6A to 6D, the upper stage blocks 1 to 4, the middle stage blocks 5 to 8, and the lower stage blocks 9 to 12 are illustrated and described by using an up-down direction or the right-left direction, and may be installed in an upward direction, a downward direction, or the like without being limited thereto.

In the operation pattern to be described below, an exposure period, a standby period, and a read period of the drive unit 2 will be described.

The exposure period referred to here refers to a period during which the light receiving unit 5 is driven by the light emission drive unit 6 to receive pulse light emission, and corresponds to a duration of the pulse light emission or a period during which the light emitting operation is performed.

Further, the read period referred to here refers to a period during which an electric signal of the pulse light emission received by the light receiving unit 5 with the drive by the light reception drive unit 7 is output.

Further, the standby period referred to here is a period during which neither the light emission drive unit 6 is driven nor the light reception drive unit 7 is driven, and is a period during which the light emitting unit 4 is cooled.

In this manner, since the upper stage blocks 1 to 4, the middle stage blocks 5 to 8, and the lower stage blocks 9 to 12 illustrated in FIGS. 6A to 6D together represent the light emitting sections of the light emitting unit 4 and the light receiving sections of the light receiving unit 5, the “light emission” in the light emitting unit 4 may be described as “exposure” performed on the light receiving unit 5 side.

The term “pulse light emission” in the present specification refers to a pulse group having a predetermined period in which light is repeatedly emitted.

The exposure of the first operation pattern is performed in any one of a state in which the upper stage blocks 1 to 4 illustrated in FIG. 6A are exposed, a state in which the middle stage blocks 5 to 8 illustrated in FIG. 6B are exposed, and a state in which the lower stage blocks 9 to 12 illustrated in FIG. 6C are exposed.

In the first operation pattern illustrated in FIG. 6D, elapsed time points are represented up to 13.5 ms in units of 0.5 ms such as 0 ms, 0.5 ms, and 1 ms. Further, in a phase difference divided into four of 0 degrees, 90 degrees, 180 degrees, and 270 degrees, the phase difference of 0 degrees is 0 to 3 ms, the phase difference of 90 degrees is 3.5 to 6.5 ms, the phase difference of 180 degrees is 7 to 10 ms, and the phase difference of 270 degrees is 10.5 to 13.5 ms.

Focusing on the upper stage blocks 1 to 4 in FIG. 6A, in a case where a phase difference is 0 degrees, as illustrated in FIG. 6D, an exposure period is set to each cell of 0 ms and 1.5 ms, and a read period is set to a cell of 3 ms. A standby period is set to each cell of 0.5 ms, 1 ms, 2 ms, and 2.5 ms.

In this manner, in the first operation pattern, a plurality of exposure periods are provided before one read period arrives, and a standby period is provided between the plurality of exposure periods. In the upper stage blocks 1 to 4, the exposure for 0.5 ms is performed twice, and thus an integration exposure time is 1 ms, which can be the same as a case where an exposure for 1 ms is performed once.

Meanwhile, as described above, thermal saturation occurs at a low current as the duration of pulse light emission is increased. That is, in a case where lighting of the light emitting sections A1 to A12 is continuously performed for 1 ms, thermal saturation occurs before the maximum current is reached, and thermal measures such as heat dissipation design are required.

Therefore, in the first operation pattern, the exposure is divided and performed two times and the standby period is provided between the two exposures, and thus a cooling period is added. Accordingly, the cooling period is provided, and the cooling is performed before thermal saturation. Therefore, a temperature at which the second exposure is started can be returned to a temperature at which the first exposure is started or a temperature close to the temperature at which the first exposure is started. By adopting the first operation pattern, it is possible to avoid a situation in which thermal saturation occurs before each light emitting section 41 of the light emitting unit 4 reaches the maximum current.

In the example illustrated in FIGS. 6A to 6D, the exposure is divided into two times, and may be divided into three or more times, for example, 10 times or 100 times without being limited thereto.

Here, as illustrated in FIG. 6D, a time for two cells (1 ms) is divided into times for one cell (0.5 ms) as the exposure period, and a time interval by two cells (1 ms) is provided between the first exposure period and the second exposure period. In this manner, the pulse light emission of the upper stage blocks 1 to 4 is performed twice with a time interval by two cells.

Further, as illustrated in FIG. 6D, the read period is a time (0.5 ms) for one cell. In this manner, the time interval between the first exposure period and the second exposure period is for two cells (1 ms), which is longer than the read period. That is, the second light emission is performed after a pause longer than the read period between the first light emission and the second light emission. Therefore, erroneous lighting is prevented.

Next, focusing on the middle stage blocks 5 to 8 and the lower stage blocks 9 to 12, in a case where a phase difference is 0 degrees in the middle stage blocks 5 to 8, an exposure period is set to each cell of 0.5 ms and 2 ms, and a read period is set to a cell of 3 ms. A standby period is set to each cell of 1 ms, 1.5 ms, and 2.5 ms.

In the lower stage blocks 9 to 12, in a case where the phase difference is 0 degrees, the exposure period is set to each cell of 1 ms and 2.5 ms, and the read period is set to a cell of 3 ms. The standby period is set to each cell of 1.5 ms and 2 ms.

Focusing on the exposures of the upper stage blocks 1 to 4, the middle stage blocks 5 to 8, and the lower stage blocks 9 to 12, as illustrated in FIGS. 6A to 6C, these exposures are not performed at the same time. That is, as illustrated in FIG. 6D, in a case where the phase difference is 0 degrees, the exposures are respectively performed at timings of each cell of 0 ms and 1.5 ms in the upper stage blocks 1 to 4, each cell of 0.5 ms and 2 ms in the middle stage blocks 5 to 8, and each cell of 1 ms and 2.5 ms in the lower stage blocks 9 to 12.

In this manner, the exposures of the upper stage blocks 1 to 4, the middle stage blocks 5 to 8, and the lower stage blocks 9 to 12 are sequentially performed with a time difference for each phase. In other words, the light emission drive unit 6 (see FIG. 1) drives the middle stage blocks 5 to 8 and the lower stage blocks 9 to 12 to emit light at a period that does not overlap with a light emitting period of the pulse light emission of the upper stage blocks 1 to 4.

Further, as illustrated in FIG. 6D, the upper stage blocks 1 to 4 are exposed at each cell of 0 ms and 1.5 ms, and the middle stage blocks 5 to 8 are exposed at each cell of 0.5 ms and 2 ms. That is, the middle stage blocks 5 to 8 are exposed at the cell of 0.5 ms cell between the cell of 0 ms and the cell of 1.5 ms at which the upper stage blocks 1 to 4 are exposed. In other words, the light emission drive unit 6 (see FIG. 1) drives one pulse light emission of two pulse light emissions for the middle stage blocks 5 to 8 at a timing of 0.5 ms, which is between the time intervals of the cell of 0 ms and the cell of 1.5 ms at which the upper stage blocks 1 to 4 emit light.

Here, as illustrated in FIGS. 6A to 6C, in the upper stage blocks 1 to 4, the middle stage blocks 5 to 8, and the lower stage blocks 9 to 12, respectively arranged in a row in the right-left direction, the middle stage blocks 5 to 8 are aligned in the up-down direction intersecting with the right-left direction of the row of the upper stage blocks 1 to 4. In the same manner, the lower stage blocks 9 to 12 are aligned in the up-down direction of the row of the upper stage blocks 1 to 4.

As described above, the upper stage blocks 1 to 4, the middle stage blocks 5 to 8, and the lower stage blocks 9 to 12 perform pulse light emission a plurality of times in a row unit. In other words, the light emission drive unit 6 (see FIG. 1) drives the upper stage blocks 1 to 4, the middle stage blocks 5 to 8, and the lower stage blocks 9 to 12 such that the pulse light emission to be performed the plurality of times is performed in a row unit.

More specifically, in a case of the first operation pattern in which the exposure periods of the upper stage blocks 1 to 4, the middle stage blocks 5 to 8, and the lower stage blocks 9 to 12 do not overlap with each other, the maximum current can be increased as compared with a case where the upper stage blocks 1 to 4, the middle stage blocks 5 to 8, and the lower stage blocks 9 to 12 are exposed at the same time. Therefore, in the case of the first operation pattern, a high current density may flow and a light output density is increased. As the distance measurement apparatus 1 (see FIG. 1), distance measurement over a longer distance may be performed with higher accuracy.

The order of the exposures of the upper stage blocks 1 to 4, the middle stage blocks 5 to 8, and the lower stage blocks 9 to 12 with the same phase difference may have an operation pattern other than the first operation pattern. For example, the upper stage blocks 1 to 4 may be exposed, and then the lower stage blocks 9 to 12 may be exposed, and then the middle stage blocks 5 to 8 may be exposed. Further, the order may be the lower stage blocks 9 to 12, the middle stage blocks 5 to 8, and the upper stage blocks 1 to 4.

Here, focusing on the read period, after two exposure periods elapse in the upper stage blocks 1 to 4, the middle stage blocks 5 to 8, and the lower stage blocks 9 to 12, one reads of the upper stage blocks 1 to 4, the middle stage blocks 5 to 8, and the lower stage blocks 9 to 12 are performed at the cell of 3 ms. Therefore, wide-angle and telescopic distance measurement can be performed.

As described above, with the first operation pattern, an integration time of light emission corresponding to one read is divided into a plurality of times, and a cooling period is provided. Accordingly, the integration time for each time is shortened, the temperature rise is reduced, and thermal saturation is reduced.

Further, with the first operation pattern, for example, a period during which the upper stage blocks 1 to 4 are being cooled, the other blocks, that is, the middle stage blocks 5 to 8 and the lower stage blocks 9 to 12 sequentially emits light onto the other regions. Accordingly, a measurement time is shortened, and motion artifacts are reduced.

In a case where the integration time is divided into a plurality of times as in the first operation pattern, a timing at which one measurement is ended at four phase differences is the same as in a case where the integration time is not divided into the plurality of times, and is not long.

Further, in the first operation pattern, the number of exposures of the upper stage blocks 1 to 4, the middle stage blocks 5 to 8, and the lower stage blocks 9 to 12 is two, and the exposure times are the same.

### Second Operation Pattern

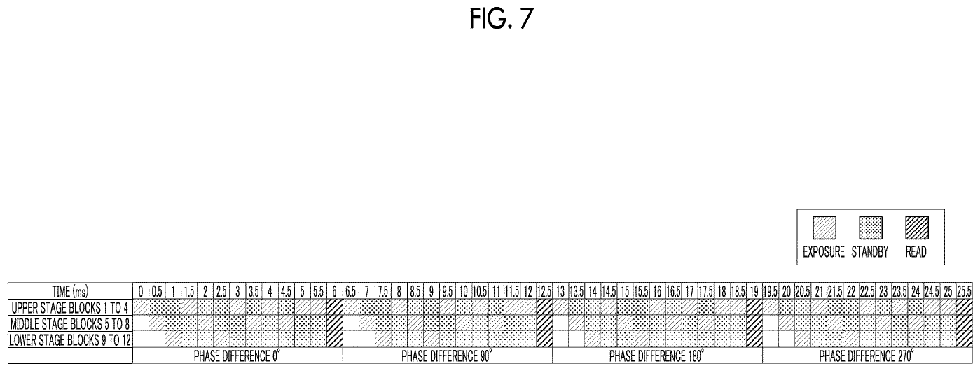

Next, a second operation pattern will be described with reference to FIG. 7.

FIG. 7 is a diagram illustrating a second operation pattern, and illustrates timings of an exposure, a standby, and a read.

Since an exposure, a standby, and a read are performed by using the upper stage blocks 1 to 4, the middle stage blocks 5 to 8, and the lower stage blocks 9 to 12 as units in the second operation pattern in the same manner as in the case of the first operation pattern (see FIGS. 6A to 6C), the illustration thereof will be omitted.

The second operation pattern illustrated in FIG. 7 has the same manner as the case of the first operation pattern described above in that an elapsed time is illustrated in units of 0.5 ms and divided into four phase differences of 0 degrees, 90 degrees, 180 degrees, and 270 degrees, and divided three stages of the upper stage blocks 1 to 4, the middle stage blocks 5 to 8, and the lower stage blocks 9 to 12 are provided.

In addition, the second operation pattern also has the same manner as the case of the first operation pattern described above in that an exposure is divided and performed a plurality of times until one read is performed, and at timings at which the exposures of the upper stage blocks 1 to 4, the middle stage blocks 5 to 8, and the lower stage blocks 9 to 12 are shifted.

On the other hand, the second operation pattern illustrated in FIG. 7 is different from a case where the first operation pattern is illustrated up to 13.5 ms in that the number of times of the exposure period is set to be large, so that the second operation pattern is illustrated up to 25.5 ms.

More specifically, the second operation pattern is different from the first operation pattern having the same number of exposures in that the number of exposures is set differently for each of the upper stage blocks 1 to 4, the middle stage blocks 5 to 8, and the lower stage blocks 9 to 12.

That is, referring to the case where the phase difference is 0 degrees, the exposure of the upper stage blocks 1 to 4 is performed at each cell of 0 ms, 1.5 ms, 3 ms, 4 ms, 5 ms, and 5.5 ms, a total of six times. In the middle stage blocks 5 to 8, the exposure is performed at each cell of 0.5 ms, 2 ms, 3.5 ms, and 4.5 ms, a total of four times. In the lower stage blocks 9 to 12, the exposure is performed at each cell of 1 ms and 2.5 ms, a total of two times.

In this manner, since the respective numbers of exposures of the upper stage blocks 1 to 4, the middle stage blocks 5 to 8, and the lower stage blocks 9 to 12 are different from each other, three region groups having different total lighting times are set.

The difference in total lighting time is reflected in measurement accuracy. That is, since an exposure time of the upper stage blocks 1 to 4 is longer than an exposure time of the middle stage blocks 5 to 8, measurement accuracy is higher than measurement accuracy of the middle stage blocks 5 to 8. On the other hand, since an exposure time of the lower stage blocks 9 to 12 are shorter than the exposure time of the middle stage blocks 5 to 8, measurement accuracy is lower than the measurement accuracy of the middle stage blocks 5 to 8.

The measurement accuracy of the upper stage blocks 1 to 4 is improved as compared with the middle stage blocks 5 to 8 and the lower stage blocks 9 to 12 which are the other blocks. Even in a case where the target object is, for example, a low reflectance object, a long-distance object, or the like, measurement can be performed.

### Third Operation Pattern

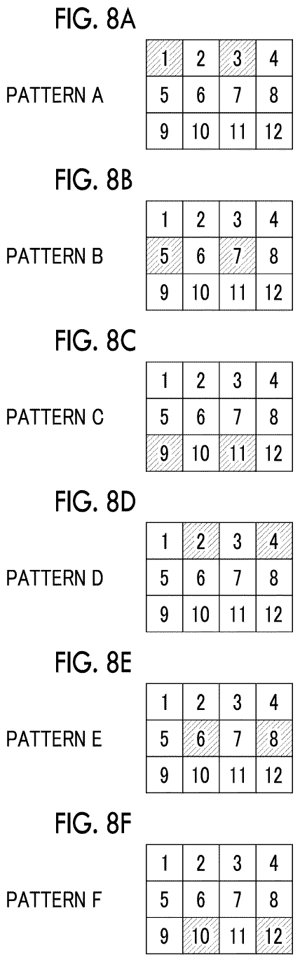

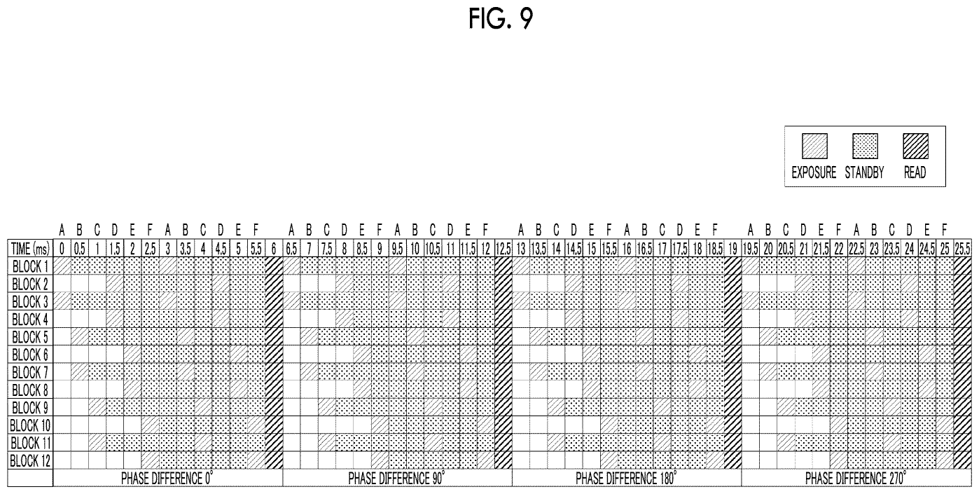

Next, a third operation pattern will be described with reference to FIGS. 8A to 8F and FIG. 9.

FIGS. 8A to 8F and FIG. 9 are diagrams describing the third operation pattern, and FIGS. 8A to 8F illustrate a position of each section of the light emitting sections A1 to A12 (see FIG. 3) and the light receiving sections C1 to C12 (see FIG. 4) in number. In FIGS. 8A to 8F, blocks that emit light at the same time are shaded. FIG. 9 is a diagram illustrating the third operation pattern indicating timings of an exposure, a standby, and a read.

As illustrated in FIGS. 8A to 8F, the third operation pattern is different from the first operation pattern (see FIGS. 6A to 6D) or the second operation pattern (see FIG. 7) described above in that the exposure, the standby, and the read are performed without using the upper stage blocks 1 to 4, the middle stage blocks 5 to 8, and the lower stage blocks 9 to 12 as units. That is, in the third operation pattern, the exposure, the standby, and the read are performed by using a part of each of the upper stage blocks 1 to 4, the middle stage blocks 5 to 8, and the lower stage blocks 9 to 12 as units.

More specifically, in FIG. 8A, the blocks 1 and 3 among the upper stage blocks 1 to 4 perform lighting at the same time, and lighting periods are the same.

Further, in FIG. 8B, the blocks 5 and 7 among the middle stage blocks 5 to 8 perform lighting at the same time, and in FIG. 8C, the blocks 9 and 11 among the lower stage blocks 9 to 12 perform lighting at the same time. Further, in FIG. 8D, the blocks 2 and 4 among the upper stage blocks 1 to 4 perform lighting at the same time, in FIG. 8E, the blocks 6 and 8 among the middle stage blocks 5 to 8 perform lighting at the same time, and in FIG. 8F, the blocks 10 and 12 among the lower stage blocks 9 to 12 perform lighting at the same time.

In this manner, the third operation pattern has the same manner as the first operation pattern (FIGS. 6A to 6D) and the second operation pattern (see FIG. 7) in that any of the upper stage blocks 1 to 4, the middle stage blocks 5 to 8, and the lower stage blocks 9 to 12 performs lighting, and the other does not perform lighting.

Meanwhile, the third operation pattern is different from the first operation pattern and the second operation pattern in that the blocks that perform lighting at the same time are a part of the upper stage blocks 1 to 4, the middle stage blocks 5 to 8, and the lower stage blocks 9 to 12.

That is, in the third operation pattern, for example, in a pattern A illustrated in FIG. 8A, in the upper stage blocks 1 to 4, the other blocks 2 and 4 do not emit light in the light emitting period of the blocks 1 and 3. In this manner, the upper stage blocks 1 to 4 include the blocks 1 and 3 that emit light at the same time in a certain light emitting period, and the blocks 2 and 4 that do not emit light at the same time.

Further, the blocks that perform lighting at the same time are not in a positional relationship adjacent to each other in the up-down direction and the right-left direction. For example, focusing on the blocks 1 and 3 in FIG. 8A, the block 2 that does not perform lighting at the same time is located between the block 1 and the block 3, and the blocks 1 and 3 that perform lighting at the same time are not adjacent to each other in the right-left direction. In the same manner, the block 6 is located between the blocks 5 and 7 in FIG. 8B, and the block 10 is located between the blocks 9 and 11 in FIG. 8C. Further, the block 3 is located between the blocks 2 and 4 in FIG. 8D, the block 7 is located between the blocks 6 and 8 in FIG. 8E, and the block 11 is located between the blocks 10 and 12 in FIG. 8F.

Therefore, with the third operation pattern, thermal crosstalk between blocks is reduced.

In the upper stage blocks 1 to 4, the right-left direction which is a direction in which the block 1 to the block 4 are arranged is an example of a predetermined direction.

A to F illustrated in FIG. 9 correspond to patterns A to F illustrated in FIGS. 8A to 8F. For example, D illustrated in FIG. 9 corresponds to the pattern D illustrated in FIG. 8D.

In the third operation pattern illustrated in FIG. 9, the number of exposures performed for one read is 2 for any of the blocks 1 to 12.

In the first operation pattern, the second operation pattern, and the third operation pattern described above, a read period is set such that the read period is to be performed in a case where a light emitting time for each of a plurality of times of pulse light emission in the upper stage blocks 1 to 4, the middle stage blocks 5 to 8, and the lower stage blocks 9 to 12 exceeds a predetermined value.

That is, for example, a total of two exposures for two cells of 0.5 ms before a read is performed on the upper stage blocks 1 to 4 of the first operation pattern (see FIGS. 6A to 6D) is 1 ms. Therefore, for example, 0.5 ms may be set as a threshold value for a total of the light emitting times, and the read may be performed in a case where the total light emitting time exceeds the threshold value. The threshold value of 0.5 ms in this case is an example of the predetermined value.

Further, a threshold value for the middle stage blocks 5 to 8 and the lower stage blocks 9 to 12 is the same as the threshold value for the upper stage blocks 1 to 4 described above.

The threshold value described above is set in a row unit.

In addition, the threshold value in the third operation pattern (see FIGS. 8A to 8F and FIG. 9) is the same as the first operation pattern in that the threshold values of all of the patterns A to F are the same, and is different from the first operation pattern in that the threshold value in the third operation pattern is not set in a row unit.

Further, for example, a total of six exposures of 0.5 ms until a read is performed on the upper stage blocks 1 to 4 of the second operation pattern (see FIG. 7) is 3 ms, and the read can be set such that the read is to be performed in a case where the total light emitting time exceeds, for example, 2.5 ms. The threshold value of 2.5 ms in this case is an example of the predetermined value.

More specifically, in the second operation pattern, as described above, the respective numbers of exposures of the upper stage blocks 1 to 4, the middle stage blocks 5 to 8, and the lower stage blocks 9 to 12 are set to be different from each other. Therefore, the threshold values of the middle stage blocks 5 to 8 and the lower stage blocks 9 to 12 are different from the threshold value of the upper stage blocks 1 to 4 described above, and the threshold value of the middle stage blocks 5 to 8 and the threshold value of the lower stage blocks 9 to 12 are different from each other.

In the same manner as the second operation pattern, the threshold value can be set according to the upper stage blocks 1 to 4, the middle stage blocks 5 to 8, and the lower stage blocks 9 to 12. The threshold value is set in a row unit.

Among the first operation pattern, second operation pattern, and third operation pattern described above, any one can be selected depending on a distance measurement condition, a distance measurement environment, or the like.

Further, the light emission drive unit 6 of the drive unit 2 may perform light emission control based on a result of light reception acquired by the acquisition unit 84, and may control any operation pattern of the first operation pattern, the second operation pattern, and the third operation pattern to be changed according to accuracy of each operation pattern, for example. Such changing of the operation pattern may be performed by using a machine learning model. The machine learning model in such a case is trained to estimate an operation pattern most appropriate for distance measurement of a target object based on the result of light reception. More specifically, the result of light reception is input to the machine learning model, and a result of selecting an operation pattern is output from the machine learning model via an intermediate layer.

Here, a light emitting operation pattern in one light emitting period to which the present exemplary embodiment is applied will be described.

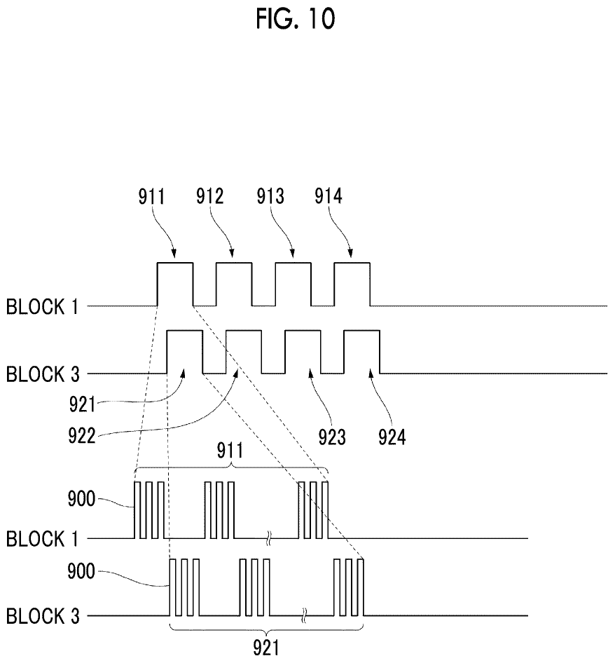

FIG. 10 is a diagram illustrating a light emitting operation pattern in one light emitting period to which the present exemplary embodiment is applied, and illustrates a case of the pattern A (see FIGS. 8A to 8F or FIG. 9) in the third operation pattern as an example.

As a light emitting operation, each light emitting section 41 (see FIG. 2 or FIG. 3) according to the present exemplary embodiment is driven by the light emission drive unit 6 (see FIG. 1), causes the VCSEL to emit light by emitting a pulse having a width of approximately 10 ns to 100 ns during a light emitting period of 500 μs a large number of times, and irradiates the corresponding irradiation section 61 (see FIG. 2, FIG. 4, or 5A to 5C) with the light.

More specifically, as illustrated in FIG. 10, each light emitting period (indicated by reference numerals 911 to 914) of the block 1 in the upper stage blocks 1 to 4 is configured with a large number of times of pulse 900. In the same manner, each light emitting period (indicated by reference numerals 921 to 924) of the block 3 is configured with a large number of times of pulse 900.

The number of times of pulse 900 constituting one light emitting period varies depending on a length of the light emitting period and a width of the pulse 900, and can be, for example, approximately several tens to several hundred times. The light emitting section 41 according to the present exemplary embodiment performs pulse light emission, for example, 10,000 times within one light emitting period.

The light emitting chip of the light emitting unit 4 (see FIG. 2) may have a part of the drive function. For example, a thyristor or the like that functions as switching may be disposed on the same surface as the light emitting surface 40 (see FIG. 2). Further, the light emitting unit 4 and the light emission drive unit 6 (see FIG. 1) may be integrally configured.

### Supplementary Notes

(((1)))

A light emitting apparatus comprising:
a light emitting unit that has a plurality of regions configured to individually emit light;
a drive unit that drives a predetermined region among the plurality of regions of the light emitting unit to perform pulse light emission; and
an acquisition unit that acquires a light reception result obtained by receiving reflected light of the light emitted from the light emitting unit toward a target object,
wherein in one acquisition acquired by the acquisition unit, the drive unit drives the predetermined region such that the pulse light emission of the predetermined region is performed a plurality of times with time intervals.

(((2)))

The light emitting apparatus according to (((1))),
wherein the drive unit drives another region, which is a region other than the predetermined region, to emit light in a period that does not overlap with a light emitting period of the pulse light emission of the predetermined region.

(((3)))

The light emitting apparatus according to (((2))),
wherein during the time interval, the drive unit drives the other region such that the other region performs at least one pulse light emission among the plurality of times the pulse light emission is to be performed.

(((4)))

The light emitting apparatus according to (((2))) or (((3))),
wherein the other region is included in a second row aligned in a direction intersecting with one direction of a first row in which regions including the predetermined region are arranged in the one direction.

(((5)))

The light emitting apparatus according to (((4))),
wherein the drive unit drives the first row and the second row such that the pulse light emission to be performed the plurality of times in the first row and the second row is performed in a row unit.

(((6)))

The light emitting apparatus according to (((4))),
wherein each of the first row and the second row has a plurality of regions that emit light at a same time in the light emitting period and a region that does not emit light at the same time.

(((7)))

The light emitting apparatus according to any one of (((1))) to (((6))),
wherein in a case where regions including a plurality of predetermined regions having a same light emitting period of the pulse light emission are arranged in a predetermined direction, the plurality of predetermined regions are not adjacent to each other in the predetermined direction.

(((8)))

The light emitting apparatus according to any one of (((1))) to (((6))),
wherein the time interval is longer than a time for the acquisition unit to acquire the light reception result.

(((9)))

The light emitting apparatus according to (((1))),
wherein the acquisition of the light reception result by the acquisition unit is set to be performed in a case where a total of light emitting times for each of the plurality of times of the pulse light emission in the predetermined region exceeds a predetermined value.

(((10)))

The light emitting apparatus according to (((9))),
wherein the predetermined value is the same for each of the plurality of regions.

(((11)))

The light emitting apparatus according to (((9))),
wherein the predetermined value is determined according to the plurality of regions.

(((12)))

The light emitting apparatus according to (((11))),
wherein the plurality of regions are arranged such that a row in which the regions are arranged in one direction is aligned in a direction intersecting with the one direction, and
the predetermined value is determined in a row unit.

(((13)))

A drive device comprising:
a drive unit that drives a predetermined region among a plurality of regions configured to individually emit light to perform pulse light emission; and
an acquisition unit that acquires a light reception result obtained by receiving reflected light of the light emitted from the plurality of regions toward a target object,
wherein in one acquisition acquired by the acquisition unit, the drive unit drives the predetermined region such that the pulse light emission of the predetermined region is performed a plurality of times with time intervals.

(((14)))

A distance measurement apparatus comprising:
a light emitting unit that has a plurality of regions configured to individually emit light;
a drive unit that drives a predetermined region among the plurality of regions of the light emitting unit to perform pulse light emission;
an acquisition unit that acquires a light reception result obtained by receiving reflected light of the light emitted from the light emitting unit toward a target object; and
a calculation unit that calculates a distance to the target object based on the light reception result acquired by the acquisition unit,
wherein in one acquisition acquired by the acquisition unit, the drive unit drives the predetermined region such that the pulse light emission of the predetermined region is performed a plurality of times with time intervals.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light emitting apparatus comprising:
a light emitting unit that has a plurality of regions configured to individually emit light;
a drive unit that drives a predetermined region among the plurality of regions of the light emitting unit to perform pulse light emission; and
an acquisition unit that acquires a light reception result obtained by receiving reflected light of the light emitted from the light emitting unit toward a target object,
wherein in one acquisition acquired by the acquisition unit, the drive unit drives the predetermined region such that the pulse light emission of the predetermined region is performed a plurality of times with time intervals.

2. The light emitting apparatus according to claim 1,
wherein the drive unit drives another region, which is a region other than the predetermined region, to emit light in a period that does not overlap with a light emitting period of the pulse light emission of the predetermined region.

3. The light emitting apparatus according to claim 2,
wherein during the time interval, the drive unit drives the other region such that the other region performs at least one pulse light emission among the plurality of times the pulse light emission is to be performed.

4. The light emitting apparatus according to claim 2,
wherein the other region is included in a second row aligned in a direction intersecting with one direction of a first row in which regions including the predetermined region are arranged in the one direction.

5. The light emitting apparatus according to claim 3,
wherein the other region is included in a second row aligned in a direction intersecting with one direction of a first row in which regions including the predetermined region are arranged in the one direction.

6. The light emitting apparatus according to claim 4,
wherein the drive unit drives the first row and the second row such that the pulse light emission to be performed the plurality of times in the first row and the second row is performed in a row unit.

7. The light emitting apparatus according to claim 5,
wherein the drive unit drives the first row and the second row such that the pulse light emission to be performed the plurality of times in the first row and the second row is performed in a row unit.

8. The light emitting apparatus according to claim 4,
wherein each of the first row and the second row has a plurality of regions that emit light at a same time in the light emitting period and a region that does not emit light at the same time.

9. The light emitting apparatus according to claim 5,
wherein each of the first row and the second row has a plurality of regions that emit light at a same time in the light emitting period and a region that does not emit light at the same time.

10. The light emitting apparatus according to claim 1,
wherein in a case where regions including a plurality of predetermined regions having a same light emitting period of the pulse light emission are arranged in a predetermined direction, the plurality of predetermined regions are not adjacent to each other in the predetermined direction.

11. The light emitting apparatus according to claim 1,
wherein the time interval is longer than a time for the acquisition unit to acquire the light reception result.

12. The light emitting apparatus according to claim 1,
wherein the acquisition of the light reception result by the acquisition unit is set to be performed in a case where a total of light emitting times for each of the plurality of times of the pulse light emission in the predetermined region exceeds a predetermined value.

13. The light emitting apparatus according to claim 12,
wherein the predetermined value is the same for each of the plurality of regions.

14. The light emitting apparatus according to claim 12,
wherein the predetermined value is determined according to the plurality of regions.

15. The light emitting apparatus according to claim 14,
wherein the plurality of regions are arranged such that a row in which the regions are arranged in one direction is aligned in a direction intersecting with the one direction, and
the predetermined value is determined in a row unit.

16. A drive device comprising:
a drive unit that drives a predetermined region among a plurality of regions configured to individually emit light to perform pulse light emission; and
an acquisition unit that acquires a light reception result obtained by receiving reflected light of the light emitted from the plurality of regions toward a target object,
wherein in one acquisition acquired by the acquisition unit, the drive unit drives the predetermined region such that the pulse light emission of the predetermined region is performed a plurality of times with time intervals.

17. A distance measurement apparatus comprising:
a light emitting unit that has a plurality of regions configured to individually emit light;
a drive unit that drives a predetermined region among the plurality of regions of the light emitting unit to perform pulse light emission;
an acquisition unit that acquires a light reception result obtained by receiving reflected light of the light emitted from the light emitting unit toward a target object; and
a calculation unit that calculates a distance to the target object based on the light reception result acquired by the acquisition unit,
wherein in one acquisition acquired by the acquisition unit, the drive unit drives the predetermined region such that the pulse light emission of the predetermined region is performed a plurality of times with time intervals.
